(19) United States
(12) Patent Application Publication
(10) Pub. No.: US 2010/0017287 A1
(43) Pub. Date: Jan. 21, 2010

(54) Method and System for Dynamic Advertising

(76) Inventors: John Ryan Caldwell, Provo, UT (US); Stephen Liddle, Orem, UT (US); Joshua Westover, Provo, UT (US); Ryan Probasco, Lehi, UT (US); David Cardon, Salt Lake City, UT (US); Grant Gordon, Provo, UT (US)

Correspondence Address: John Ryan Caldwell, Building A, Suite 220, 34 East 1700 South, Provo, UT, 84606, US

(21) Appl. No.: 12/504,662

(22) Filed: Jul. 17, 2009

Related U.S. Application Data
(60) Provisional application No. 61/135,124, filed on Jul. 17, 2008.

(51) Int. Cl. G06Q 30/00

(52) U.S. Cl. 705/14.43; 705/14.46; 705/14.58; 705/14.54; 705/14.55; 705/14.66; 705/14.52; 705/14.49; 705/14.73

(57) ABSTRACT

A system and methods for advertising to targeted candidates and optimizing the advertisements to improve candidate response. The method and system enable an entity to advertise a need of an entity to a targeted group of candidates. After information about the need is received and the candidate target group is identified, the information is converted into a plurality of advertisements and distributed to a plurality of publishers that are within the candidate target group. The advertisements are displayed to candidates when they access at least one of the plurality of publishers. The advertisements are optimized to improve the response of the candidate target group by adjusting at least one manual control on a computer-network interface.

### CROSS-REFERENCE TO RELATED APPLICATIONS

This application claims the benefit of priority of U.S. Provisional Patent Application Ser. No. 61/135,124, filed Jul. 17, 2008, and entitled, “Dynamic Advertising System,” the subject matter of which is hereby incorporated by reference herein.

### FIELD OF THE INVENTION

The present invention relates generally to methods and a system for advertising. More particularly, the present invention relates to methods and a system for targeting candidates and optimizing advertising.

### BACKGROUND OF THE INVENTION

Conventional advertising takes many forms including radio advertisements, television advertisements, billboards, newspapers, etc. Companies aim to maximize their advertising efforts and increase the effectiveness of the advertisement by determining the most effective message to promote, the proper advertising medium, and an effective format.

One of the major obstacles in creating effective advertising is measuring a candidate response to a particular advertisement. Traditionally companies have used focus groups and surveys in order to obtain candidate response information about their advertisement campaigns and use the response information to adjust or manipulate the campaigns. Unfortunately, these techniques of generating candidate response information are often inadequate and inaccurate. One problem with the techniques is the amount of time it takes to receive feedback and broadcast a new advertising campaign based on the results; furthermore, new campaign may or may not have the same candidate response as the previous campaign. Therefore, it may require multiple focus groups or surveys to determine an effective campaign, as well as a significant amount to time. An additional problem with conventional advertising is the general inability to advertise directly to the most appropriate target audience for the advertisement.

These advertising deficiencies are prevalent in various advertising spheres including, product advertising, niche product advertising, political campaigns, employment recruiting, etc.

There are currently many advertising resources available for employment recruiting. Perhaps the most common recruiting method is direct advertising by employers in the newspaper or a magazine that is targeted to people having specific skills (e.g., engineers, attorneys, computer programmers, etc.) A typical employment advertisement will generally include a brief description of the available position, along with information to contact the employer.

Many disadvantages are inherent in this conventional recruiting method. For instance, a magazine or newspaper has a limited amount of subscribers and generally services only a limited region. Therefore, a company's advertisement may never be seen by many qualified people outside of that region. In order to distribute the advertisement more universally, it may be necessary for the employer to run the advertisement in several newspapers or magazines, thus substantially increasing the advertising expense incurred by the company.

In an attempt to increase the scope of their advertising, some companies have been using the Internet to post employment opportunities. For example, a company may set up its own homepage to post various job openings. Anyone can then access the company's home page, determine which positions at the company are available, and send a resume to the company. Although a home page can be a useful tool in enabling a company to expand it's advertising capabilities, a home page requires that an applicant be aware that the company exists and has a home page on the Internet. Hence, if the applicant has never heard of the company, the applicant would not be aware that the company has a home page. Therefore, many highly qualified candidates may overlook a company's advertisement because they simply are not aware of the company's existence.

Several advertisement agencies have recognized these potential shortcomings and have developed job boards on the Internet. A job board, is an electronic bulletin board on which messages can be posted as on a conventional bulletin board. A job board is advantageous because it provides a single location at which many companies can post employment opportunities. However, several problems are inherent with job boards. One significant problem is that job boards only target people who are actively seeking employment, therefore passive candidates who are not currently looking for a job, like already employed top-performers, are not likely to see such advertisements. Additionally, qualified candidates may not apply to a job due to the format of the advertisement or information included.

It can thus be seen that a need exists for improved advertising to target candidates and optimize advertisement performance.

### BRIEF SUMMARY OF THE INVENTION

Described herein is a system and method which will maximize the scope of a company's advertising efforts while providing the ability to target candidates and optimize advertising by making real time adjustments to improve candidate response and making it possible to advertise to both active and passive candidates.

To this end, one aspect of the present invention provides methods of advertising that satisfies the need of targeting candidates and optimizing the advertisement to improve candidate response. The method includes receiving information related to a need associated with an entity and identifying at least one candidate target group to advertise the need. The method further includes converting information received into a plurality of initial advertisements and distributing the advertisements to a plurality of publishers that are within the candidate target group. The advertisements are displayed to candidates when the candidate accesses at least one of the plurality of publishers. The method further includes optimizing the advertisements to improve the response of the candidate target group by adjusting at least one manual control on a computer-network interface.

In another aspect, the methods may include advertising directed to employment recruiting. The method includes receiving information related to a hiring need associated with a business entity and identifying at least one candidate target group to advertise the hiring need. The method includes converting information received into a plurality of initial advertisements and distributing the advertisements to a plurality of publishers that are within the candidate target group. The advertisements are displayed to candidates when the candidate accesses at least one of the plurality of publishers. The method further includes optimizing the advertisements to improve the response of the candidate target group by adjusting at least one manual control on a computer-network interface.

According to another aspect of the present invention, a system for advertising via a computer-network includes a server having a means for receiving information related to a need of an entity and a means for identifying at least one candidate target group in which to advertise the need. The system also comprises a computer-network interface associated with the server and at least one manual control on the computer-network interface configured to optimize a response of the candidate target group. The server is further configured to convert the information into a plurality of initial computer-network advertisements and distribute the plurality of initial computer-network advertisements to a plurality of publishers.

Other features and advantages of the present invention will be more apparent to those of skill in the art through consideration of the ensuing detailed description, the accompanying drawings, and the appended claims.

### BRIEF DESCRIPTION OF THE DRAWINGS

In the drawings, which depict embodiments of various features of the present invention, by way of example only:

FIG. 1 is a flow chart of a method for advertising;

FIG. 2 is an example of a computer-network interface within a server for use in advertising;

FIG. 3 is a flowchart illustrating an example of contracting for placement of advertisements; and

FIG.4 is an example of a system for advertising.

### DETAILED DESCRIPTION OF THE INVENTION

In the following detailed description, reference is made to various specific embodiments in which the invention may be practiced. These embodiments are described with sufficient detail to enable those skilled in the art to practice the invention, but it is to be understood that other embodiments may be employed and changes may be made without departing from the spirit or scope of the present invention.

The term “advertisement,” as used herein, is intended to include any advertisement that is capable of optimization. The advertisement could be computer-network based, web-based, printed, or broadcasted.

The term “publisher” used in the following description may include any advertising forum capable of targeting candidates and optimizing the advertisement. The term should be understood to include computer-networks, websites and email. The publisher need not be computer-based. The publisher could be print media, such as newspapers, magazines, journals, flyers, billboards, etc. The publisher could also be broadcast media such as radio and television.

The term “advertisement campaign” used in the following description may include all advertisements that are distributed to all publishers for an entity. The term should be understood to include all advertisements that relate to a need of an entity that appear in any venue over a period of time. The period of time may be limited or may be ongoing until the entity decides to end the campaign or the need is fulfilled.

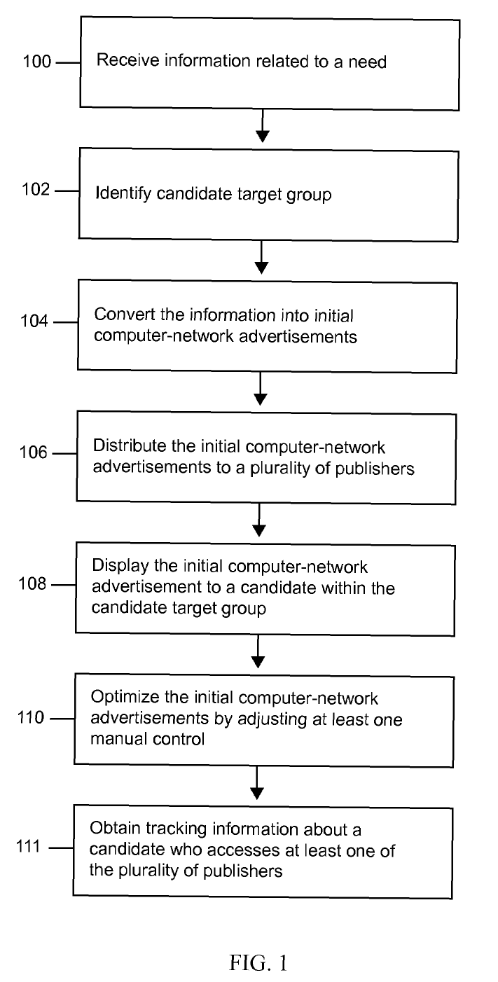

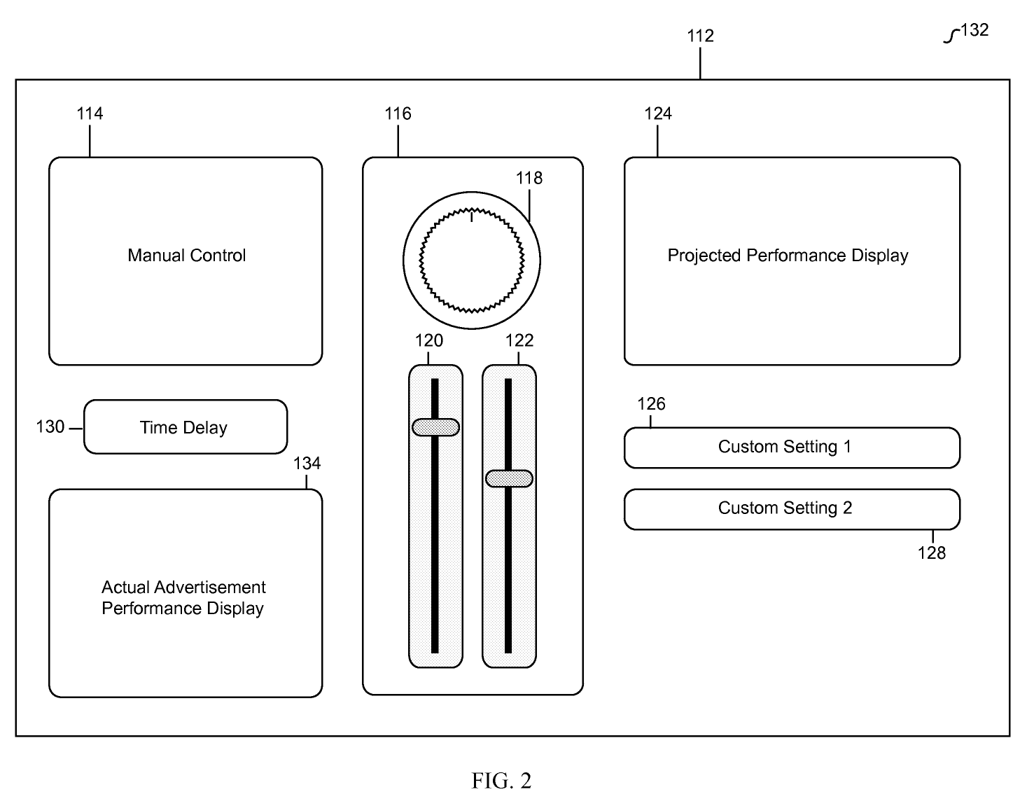

FIG. 1 illustrates a flowchart of a method for advertising. In step 100, information relating to at least one need is obtained. This information may be obtained from an entity, an employee of the entity, a service provider, a third party associated with the entity, etc. This information may be obtained through a server of the service provider. This information may include but is not limited to the location of advertisement sought, desired advertisement design and media, and a description of the at least one need. In step 102, the target candidate group is identified. The target candidate group may be an extensive group capable of including a general audience or the target candidate group may be specific to target a particular type of viewer or candidate. The target candidate group may be categorized in any number of ways including age, geographic location, job skills, personal interests, behavioral or profile. In step 104, the obtained information is converted into an advertisement. The advertisement can be used in a variety of publishing venues and therefore the information can be converted into a plurality of advertisements having a unique format and may contain distinctive information based on the publisher of the advertisement. For example, the information used for placement on a website may be converted into a media rich advertisement whereas the information used for placement in a newspaper may be converted into a text only advertisement or a text and image advertisement. In step 106, the advertisements are distributed to publishers. Based on the information obtained, this advertisement can be configured for placement in a variety of publishing venues. One category of publishing venues is websites, including websites that the target candidate group frequents. Although websites are a particularly useful environment for the systems and methods described herein, other examples of publishing locations include printed media, such as journals and trade magazines, email, roadside billboards, and broadcast media such as radio and television advertisements. In step 108, the advertisements are displayed to candidates who are within the candidate target group. The advertisement may be displayed directly to a candidate. Alternatively, the advertisement may be delivered to a publisher for displaying to a candidate. In step 110, the performance of the advertisement is optimized by adjusting at least one manual control. As shown in FIG. 2, the manual control 114 is displayed on a computer-network interface 112 and may have one or more manual controls 114, each coupled to an individual rule. The manual controls 114 allow for individual adjustment to any of a variety of factors.

The manual controls 114 may be initially set to default settings. The default settings may be incorporated into the advertisement campaign based on the candidate target group or the publishers. For example, a candidate target group of females age twenty may have different default settings than a candidate target group of chemical engineers with five or more years of experience. Similarly, default settings for a website advertisement campaign may be different then default settings for a newspaper advertisement campaign. The manual controls 114 may also be initially set to initial manual settings defined by a user instead of using default settings. A user is a person with access to the computer-network interface 112 and may include a servicer provider, an entity, a third party associated with an entity, etc. Alternatively, the manual controls 114 may be initially set with some manual controls being set to default settings, and some manual controls being set to initial manual settings.

The manual control 114 is useful for making quick, general, high level adjustments to an overall advertisement campaign. The manual control 114 is used to set a level of increased or decreased emphasis on a certain factor. A rule is associated with the manual control 114 that specifies an emphasis of adjustment based on the position of the manual control. Since each factor may be adjusted by an individual manual control 114 it may be that some factors are highly adjusted while other factors are mildly adjusted or not adjusted at all. It may also be that all factors are equally adjusted. The adjustments to the factors may immediately be incorporated into the advertisement campaign or the incorporation of the adjustments may be time delayed individually or concurrently. Therefore, it is possible to adjust the manual control 114 for certain factors and specifying a time delay 130 so that the factors of the advertisement campaign are not changed for a certain period of time. This may be useful for an advertisement that is adjusted based on the time of day; for example, if a certain adjustment optimizes the advertisement performance during the night, the manual control may be adjusted during work hours to avoid having to make the adjustment immediately before the adjustments are incorporated. The time delay 130 is also useful for advertisements appearing in print media where the adjusted advertisement are delayed until the next publication of the advertisement.

The manual control 114 may include a master control 118 linked 116 to at least one manually adjustable sub control 120, 122, or may be an individual master control 118 or an individual manually adjustable sub control 120. If linked 116, adjusting the master control 118 will automatically adjust the manually adjustable sub controls 120, 122 based on a pre-determined algorithm or adjusting the manually adjustable sub controls 120, 122 will automatically adjusted the master control 118. The manual controls 114 can optimize the advertisement campaign by managing in autopilot mode, where the master control 118 is used to optimize the performance of the advertisement, in manual mode, where the manually adjustable sub control 120 is used to optimize the performance of the advertisement, or in a custom preset mode, using a custom preset 126 that is saved within a computer-network and accessible on the computer-network interface 112.

The master control 118 may be displayed as, but is not limited to, a dial, lever, slider, plus/minus buttons, input box, or thermostat. For example, if the master control 118 is a dial it would be manipulated by the user by twisting the dial, similar to the volume adjustment on a stereo. The manually adjustable sub control 120 may be displayed as, but is not limited to, a vertical or horizontal slide that can slide to adjust at least one factor. For example, if the factor is a geographic target area the slide adjusts a target geographic metric type to broaden or narrow the geographic target area. The slide may include but is not limited to zip codes, cities, states, regions, and nations. The manually adjustable sub control 120 may also be a horizontal dual control or vertical dual control that allows any two factors to be controlled simultaneously.

Custom presets 126, 128 is a function that allows a user to set and save at least one preferred settings on the system. The user utilizes the master control 118 and/or the manually adjustable sub control 120 to adjust the system to an optimal level for the entity's needs and saves the settings for future use. If a custom preset 126 is activated the master control 118 and manually adjustable sub controls 120 will adjust to the user's preset settings. Custom presets 126 are used for convenience and efficiency. The custom preset 126 may also be saved in the computer-network interface 112 to be used by the entity without the need for creating a new custom preset. The user may assign a custom preset 126 for one manual control 114 or select multiple manual controls 114 to assign a custom preset 126.

The manual control 114 may be used to adjust at least one of a variety of factors. The factors may include but are not limited to targeting categories and associated levels, geographic categories, quality, priority charge, occupational categories, advertisement categories, time duration, and cost factors. Cost factors may include a bid amount for an advertisement's appearance on a website, also called an impression, a bid amount for an action of a candidate such as a click-through, a maximum bid amount for an impression or action, and a budget for the advertisement campaign. Advertisement categories may include advertisement type, advertisement size, and advertisement content, including whether a referral reward, enticing element, or other incentive is included in the advertisement.

The manual control 114 may utilize a model of adjustment rather than simply a calculated adjustment to the plurality of manual controls 114. In one model of adjustment, the manual control 114 may be used to specify a degree of quality relaxation or stringency. The manual control 114 controlling the degree of quality, would be used to specify the accurateness of the targeting criteria and whether advertisements would be permitted to be delivered to publishers that are outside the publishers that are within the candidate target group or whether the advertisement would be limited to a restricted set of publishers within the candidate target group. Therefore, the model would permit advertisements to be delivered to locations that are outside the publishers within the candidate target group to expand the possible publishers for the advertisements. The model could also be used to reduce the amount of possible publishers that are within the candidate target group or reduce the likelihood that an advertisement would be published on a particular publisher or type of publisher within the candidate target group. This model is generally a non-competition model because it allows advertisements to be published in publishers where other entity's advertisements are not being published. However, using this model it is still possible to have limited competition between entities or between two advertisement campaigns of a single entity. This model may be useful if an entity is having difficulty identifying candidates for a particular need using a particular candidate target group and publishers within the particular candidate target group.

In another model of adjustment, the manual control 114 is provided in a competition model, which permits the preference of one entity's advertisement over the advertisement of another entity using a quality value. The quality value is the measurement of the strength of a match between an advertisement and a candidate and could be based on many different quality dimensions. For example, an advertisement might be assigned a weight or preference value that is multiplied by an entity's calculated quality value. The advertisement with the highest product of weight and quality would be selected or favored, over other advertisements when both advertisements are attempting to be published on the same publisher. In another example, a number may be assigned to all the advertisements that are permitted to be displayed on a particular publisher and the advertisement that is displayed is selected by using a random number or pseudo-random number generator.

The quality value may be permanent which allows for the quality value to remain in place with no further action to be taken by the entity. Alternatively, the quality value may be limited to a period of time, a budgetary amount, or another triggering limitation.

In one example, an advertisement listing ranking algorithm is used as a competitive model. Advertisements within a candidate target group are given a competitive bid rank based on a bid ranking assigned by each advertisement's entity. This competitive bid rank is used to bid against other advertisements for placement on a publisher. The bid ranking might be based on the maximum cost per click the entity is willing to pay, the maximum budget, the maximum budget per unit of time, or other competitive criteria. It may be possible to have ties in competitive bid ranks. The competitive bid ranks may then be normalized to be real numbers between the values of 0 and 1. The advertisement with the lowest competitive bid rank would have a value of 0 and the advertisement with the highest competitive bid rank would have a value of 1. All advertisements between the highest and lowest competitive bid ranks would have intermediate competitive bid ranks linearly distributed between 0 and 1. If more than one advertisement had the same competitive bid rank both advertisements would be given the lower of the two possible values. For example, if four advertisements had a bid ranking of [10, 5, 5, 2.5] the competitive bid rank for the four advertisements would be [1, 3, 3, 4] respectively, and the corresponding normalized values for the four advertisements would be [1, 0.25, 0.25, 0]. Alternatively, the advertisements with the same competitive bid rank could be given the higher of the two possible values or the two possible values could be randomly assigned.

The advertisement listing ranking algorithm can further comprise randomly determining or assigning a percentage of advertisement impressions to “regular” mode ranking or “probe” mode ranking. The regular mode ranking calculates the quality value using a primary quality formula. The probe mode ranking calculates the quality value using a secondary probe formula. The quality value could be based on many different quality dimensions. The quality value may be stored in a database and it is possible that the job listing ranking algorithm can look up the stored value. It is also possible to have an alternate ranking process that dedicates a given percentage to trial advertisements, which will publish lower-ranked advertisement listing on publishers. These trial advertisements are used to determine if the lower-ranked advertisement listing might have a higher performance than a higher-ranked advertisement listing.

The advertisement listing ranking algorithm can further comprise ranking the advertisement listing by the formula competitiveBidWeight*competitiveBidRankValue+qualityWeight*qualityValue. The competitiveBidWeight and the qualityWeight could be stored in a database, and could have separate weights for normal and probe mode ranking. An actual advertisement charge may be determined according to the competitive bid ranking or other criteria such as bid ranking. The actual advertisement charge is the price that is charged to an entity for an individual advertisement. The actual advertisement charge is assigned so that a lower-ranked advertisement listing is not charged more than a higher-ranked advertisement listing.

A quality formula for the advertisement listing ranking algorithm is (w₁*factor₁+ . . . wₙ*factorₙ)/(w₁+ . . . +wₙ). Each factor will be given a normalized value based on the value in a database related to each advertisement listing. There may be a plurality of quality formulas having at least one formula for the regular mode and at least one formula for the probe mode. A user may choose which factors to include and their associated weights. Quality dimensions for an advertisement listing may include but are not limited to click-through rate, which is the number of clicks divided by the number of impressions, a forward rate, which is the number of referrals per number of impressions, whether an advertisement includes a referral reward and the amount of referral reward. If the advertisement listing ranking algorithm is being used for recruiting advertisements then quality dimensions may also include but are not limited to the application rate, which may be the rate of expressions of interest for the advertisement or actual resumes submitted to the business entity, hire rate, which may be measured as the number of hires per number of impressions, number of hires per number of clicks, or number of hires per number of applications, etc., and whether the job listing displays a salary amount and the amount of salary.

The manual control 114 may also control a priority charge which is used for prioritizing a user's advertisement over advertisements of another user. An entity could pay a priority charge as a one-time payment, a series of payments, or a per-advertisement payment.

The manual control 114 may also be configured to be adjusted using an arithmetic adjustment. The adjustment may be linear, but may also follow more complex formulas or calculations as desired. It may also be that the adjustment of factors follows discrete steps. For example, a geographic targeting factor may only have three settings, a metro area, a nation, or world-wide. It may be that a threshold amount of emphasis may be needed to raise the geographic target from the metro area to the nation, therefore an arithmetic calculation may be used to adjust the geographic target. The linear adjustment may be useful to adjust a factor through multiplication of a number corresponding to the amount of emphasis or de-emphasis as selected by the user through the manual control.

A change to the manual control 114 may be reflected by displaying estimated results, such as a cost estimate or estimate of cost per activity. For example, if the manual control 114 controlling maximum budget is adjusted to increase or decrease the advertising budget of an entity a table may be displayed showing an estimated amount of impressions for the new budget, which may be further broken down to show the cost per impression for the new budget on specific websites, and an estimated period of time until the new budget is exhausted. The manual controls 114 will not necessarily display estimated results; however, if the manual control 114 does display estimated results, the display will display particular estimates based on the manual control that was adjusted. The estimated results may also be modified to display results that the entity may request. The estimated results may be displayed in a projected performance display area 124. The projected performance display 124 area only displays estimated results and is therefore distinctly different from a statistical results report.

The method described in FIG. 1 may further comprise obtaining tracking information 111 about a candidate after a candidate accesses at least one of the plurality of publishers. If an advertisement is active, which means the advertisement is capable of being activated by a candidate through a click or other action, the advertisement may obtain tracking information 111 about the candidate who accessed the advertisement. The method may also include producing activation information. This information would be sent to a server used by an entity or a service provider for tracking activation rates and activity.

The computer-network interface 112 of FIG. 2 may also comprise an actual advertisement performance display area 134. The actual advertisement performance display area 134 may have and maintain metrics on the success of an advertisement or multiple advertisements. Thus an entity will be able to view, in real time (or near real time depending on the type of publisher), the performance of an advertisement. The actual advertisement performance display area 134 may display metrics, including but not limited to, click through rate, forward rate, cost of advertisement, general success rate, application rate (if used for recruiting purposes), and hire rate (if used for recruiting purposes). For example, a website on which an advertisement is published may display a metric that is relatively greater than other website's metrics. This information may be useful for the entity to track the performance of a particular advertisement or publisher and allow the entity to make decisions regarding the advertisement performance based on the metrics.

One instance in which this method of advertising could be used is for recruiting purposes, wherein a business entity with a hiring need would use the above described method of advertising to find potential candidates for the hiring need. The candidate target group could be further reduced to a group of interested prospects. The group of interested prospects are those in the candidate target group that view an advertisement and demonstrate an interest, either by clicking on an active advertisement or taking another action, such as calling the entity or service provider, to express an interest. The group of interested prospects may be further reduced to quality leads. The quality leads are those candidates who correspond to the at least one hiring need of an entity.

This method of advertising could also be used for advertisements related to consumer products, political organizations, niche products, etc.

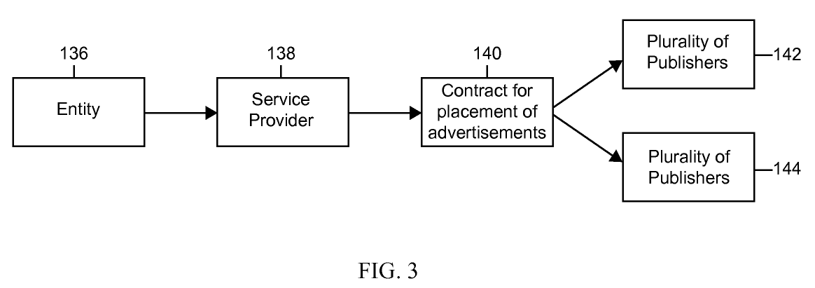

Typically, an entity 136 using this method of advertising would contact a service provider 138 who provides a service of advertisement, as shown in FIG. 3. The entity 136 and service provider 138 would form a contract for a placement of advertisements 140 in a plurality of publishers. The service provider 138 may have contracts with the plurality of publishers 142, each at a potentially different charging rate or charging terms. The entity 136 may select to advertise with the plurality of publisher 142 in which the service provider 138 has a contract or may choose to advertise with publishers 144 in which the service provider 138 does not have a contract. The contract for placement of advertisements 140 may be for a fixed number of advertisements, a percentage of advertisements, a maximum budget for advertisements, etc. The service provider 138 may charge the entity 136 for the service of advertisements. The charge for the advertisements may vary and may include, but are not limited to, a number of sales or cost per action, a number of clicks or cost per click, a return correspondence such as a postcard, or impressions made on candidates or cost per thousand. Other charging methods could also be used, for example in recruiting applications, the cost per action could be substituted with a cost incurred per hire or a cost for the receipt of a resume. It is also possible that the charging method could be a fixed membership fee paid by the entity 136; this payment could be a one-time fee or a periodic fee in order to have access to the service of advertisements.

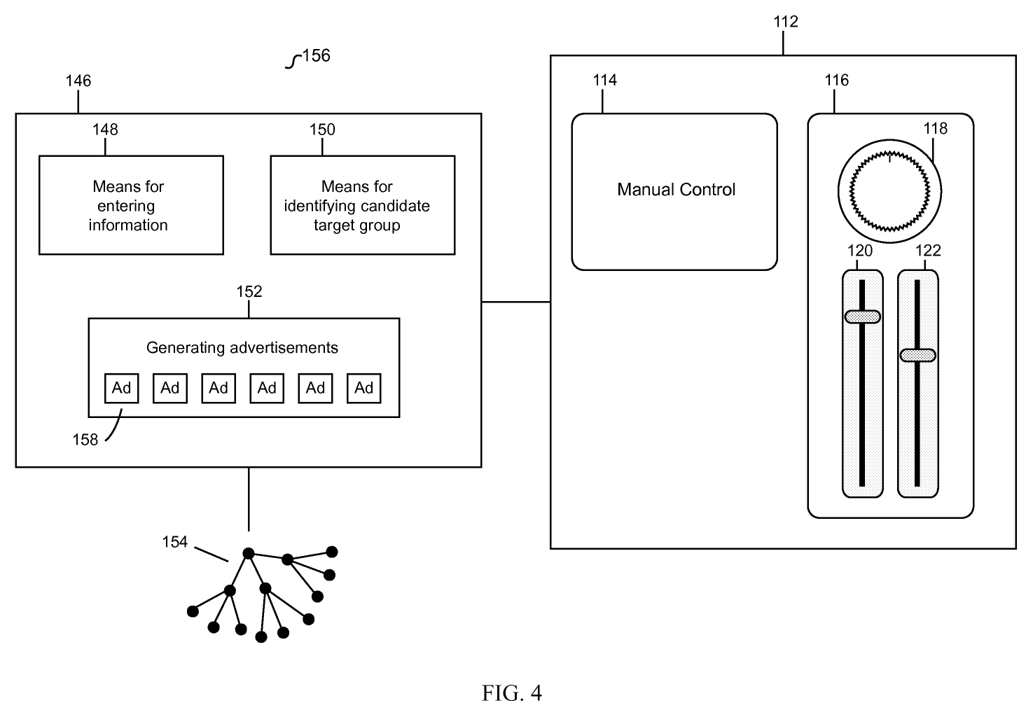

A system of advertising is shown in FIG. 4. The system 156 comprises a server 146 with a means for receiving information 148 related to at least one need of an entity 148. The information may be receiving from an entity, a servicer provider, an employee of the entity, a third party associated with the entity, etc. The means for receiving information 148 may be a screen whereby the user may view and enter certain information. For example, the information could be the type of advertisement, the type of publishers in which to advertise, the format of the advertisement, etc. The means for receiving information 148 may be a drop down menu for a field, or the information may be manual typed into a field. The server 146 also comprises a means for identifying at least one candidate target group 150 in which to advertise. The means for identifying at least one candidate target group 150 may be a screen for specifying a candidate target group for an advertisement campaign. The user may identify a customized candidate target group or select a preset candidate target group. Using this system, the candidate target group can be profiled on a broad level or a granular level. For example, the candidate target group could be a broad profile category set (i.e., Industry: Technology) and then a more detailed sub profile category set (i.e., Career Type: Database Administration, Design, Software Development), and even further to a very granular sub profile category set (Skill Sets: DB2, Microsoft SQL Server). In this way, an entity's advertisements for a need may be directed to a plurality of publishers that are more likely to elicit a response of the candidate target group. The means for identifying at least one candidate target group 150 may be a drop down menu for a field, or the information may be manual typed into a field. The means for identifying at least on candidate target group 150 could also include geographic targeting information relative to the need.

A computer-network interface 112 may be associated with the server 146. The computer-network interface 112 may comprise at least one manual control 114 that is configured to optimize a response of the candidate target group. As described above in reference in FIG. 2, the computer-network interface 112 may also comprise a master control 118 linked to manually adjustable sub-controls 120, 122.

The system 156 can further comprise a server 146 that is configured to convert the information 152 into a plurality of initial computer-network advertisements 158 and distribute the plurality of initial computer-network advertisements to a plurality of publishers 154.

Although the present invention has been described with respect to the illustrated embodiments, various additions, deletions, and modifications are contemplated as being within its scope. Therefore, it must be understood that the illustrated embodiments have been set forth only for the purposes of example and should not be taken as limiting the invention as defined by the following claims.

The words used in this specification to describe the invention and its various embodiments are to be understood not only in the sense of their commonly defined meanings, but to include by special definition in this specification, structure, material, or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements that are literally set forth, but all equivalent structure, material, or acts for performing substantially the same function in substantially the same way to obtain substantially the same result.

In addition to the equivalents of the claimed elements, obvious substitutions now or later known to one of ordinary skill in the art are defined to be within the scope of the defined elements.

The claims are thus to be understood to include what is specifically illustrated and describe above, what is conceptually equivalent, what can be obviously substituted and also what essentially incorporates the essential idea of the invention.

What is claimed is:

1. A method of advertising comprising:
receiving information related to at least one need associated with an entity;
identifying at least one candidate target group in which to advertise the at least one need;
converting the information into a plurality of initial computer-network advertisements;
distributing the plurality of initial computer-network advertisements to a plurality of publishers within the at least one candidate target group;
displaying at least one of the plurality of initial computer-network advertisements to a candidate within the at least one candidate target group after the candidate accesses at least one of the plurality of publishers; and
optimizing the plurality of initial computer-network advertisements to improve a response of the at least one candidate target group by adjusting at least one manual control on a computer-network interface.

2. The method of claim 1, wherein receiving information related to the at least one need comprises information related to at least one consumer product.

3. The method of claim 1, wherein receiving information related to the at least one need comprises information related to at least one hiring need of a business entity.

4. The method of claim 1, wherein receiving information related to the at least one need comprises information related to at least one political campaign.

5. The method of claim 1, wherein the at least one manual control adjusts at least one of advertisement controls, targeting controls, cost controls, and management controls.

6. The method of claim 1, wherein identifying the candidate target group comprises at least one of geographic targeting, contextual targeting, behavioral targeting, profile targeting and demographic targeting.

7. The method of claim 1, wherein the at least one manual control further comprises at least one master control linked to at least one sub control.

8. The method of claim 7, wherein the at least one manual control is adjusted by the least one master control.

9. The method of claim 7, wherein the at least one manual control is adjusted by the at least one sub control.

10. The method of claim 1, wherein the at least one manual control is set to a custom preset mode.

11. A method of employment recruiting, comprising:
receiving information related to at least one hiring need associated with a business entity;
identifying at least one candidate target group in which to advertise the at least one hiring need;
converting the information into a plurality of initial computer-network advertisements;
distributing the plurality of initial computer-network advertisements to a plurality of publishers within the at least one candidate target group
displaying at least one of the plurality of initial computer-network advertisements to a candidate within the at least one candidate target group after the candidate accesses at least one of the plurality of publishers; and
optimizing the plurality of initial computer-network advertisements to improve the response of the at least one candidate target group by adjusting at least one manual control on a computer-network interface.

12. The method of claim 11, wherein the at least one manual control adjusts at least one of advertisement controls, targeting controls, cost controls, and management controls.

13. The method of claim 11, wherein identifying the candidate target group comprises at least one of geographic targeting, contextual targeting, behavioral targeting, profile targeting and demographic targeting.

14. The method of claim 11, wherein distributing the plurality of initial computer-network advertisements comprises distributing the plurality of initial computer-network advertisements to the at least one of the plurality of publishers having a high quality value.

15. The method of claim 11, further comprising reducing the at least one candidate target group to a group of interested prospects.

16. The method of claim 15, further comprising reducing the group of interested prospects to quality leads, wherein the quality leads correspond to the at least one hiring need.

17. A system for advertising via a computer network, comprising:
a server for generating targeted advertisements comprising:
a means for receiving information related to at least one need of an entity; and
a means for identifying at least one candidate target group in which to advertise the at least one need;
a computer-network interface associated with the server; and
at least one manual control on the computer-network interface configured to optimize a response of the candidate target group;
wherein the server is configured to convert the information into a plurality of initial computer-network advertisements and distribute the plurality of initial computer-network advertisements to a plurality of publishers.

18. The system of claim 17, wherein the at least one manual control further comprises at least one master control linked to at least one sub control.

19. The system of claim 17, wherein the at least one manual control adjusts at least one of advertisement controls, targeting controls, cost controls, and management controls.

20. The system of claim 18, wherein the at least one manual control is adjusted by at least one of the at least one master control, the at least one sub control or custom presets.
